(19) United States
(12) Patent Application Publication
(10) Pub. No.: US 2019/0297422 A1
(43) Pub. Date: Sep. 26, 2019

(54) BINAURAL RECORDING DEVICE WITH DIRECTIONAL ENHANCEMENT

(71) Applicant: 3DIO, LLC, Vancouver, WA (US)

(72) Inventor: Jeffrey ANDERSON, Vancouver, WA (US)

(21) Appl. No.: 16/358,431

(22) Filed: Mar. 19, 2019

Related U.S. Application Data
(60) Provisional application No. 62/645,563, filed on Mar. 20, 2018.

(51) Int. Cl. H04R 5/04; H04R 5/027

(52) U.S. Cl. CPC H04R 5/04; H04R 5/027

(57) ABSTRACT

Apparatuses, methods and storage medium associated with a binaural recording arrangement with directional enhancement are disclosed herein. In particular, a first audio signal of a first microphone of a binaural recording device and a second audio signal of a second microphone of the binaural recording device may be enhanced with audio signals received from directional microphones located around the binaural recording device. The binaural recording device may receive the audio signals from the directional microphones and process and mix the audio signals with the first audio signal and the second audio signal to produce a first directionally-enhanced binaural audio signal on a first output channel and a second directionally-enhanced binaural audio signal on a second output channel. Other embodiments may be described and/or claimed.

### CROSS-REFERENCE TO RELATED APPLICATION

This application claims the priority benefit of the earlier filing date of U.S. Provisional Application No. 62/645,563, filed Mar. 20, 2018, which is hereby incorporated herein by reference in its entirety.

### TECHNICAL FIELD

The present disclosure relates to the field of binaural sound recording. More particularly, the present disclosure relates to the enhancement of binaural sound recording via directional sound enhancement.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advancements in audio recording and recording playback technology has led to the development of binaural sound recording. In particular, binaural sound recording systems may attempt to record sounds as a human would hear the sounds and produce an audio recording that may be played back to replicate the sounds as the human would have heard the sounds. However, legacy binaural sound recording systems often presented issues with ambient sounds being properly represented in the audio recording.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example recording arrangement, according to various embodiments.

FIG. 2 illustrates an example binaural recording device, according to various embodiments.

FIG. 3 illustrates an example binaural microphone fixture, according to various embodiments.

FIG. 4 illustrates example processing circuitry, according to various embodiments.

FIG. 5 illustrates an example procedure for performance by the processing circuitry of FIG. 4, according to various embodiments.

### DETAILED DESCRIPTION

Apparatuses, methods and storage medium associated with binaural recording arrangement with directional enhancement are disclosed herein. In particular, a first audio signal of a first microphone of a binaural recording device and a second audio signal of a second microphone of the binaural recording device may be enhanced with audio signals received from directional microphones located around the binaural recording device. The binaural recording device may receive audio signals from the directional microphones and process/mix the audio signals with the first audio signal and the second audio signal to produce a first directionally-enhanced audio signal on a first output channel and a second directionally-enhanced audio signal on a second output channel.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

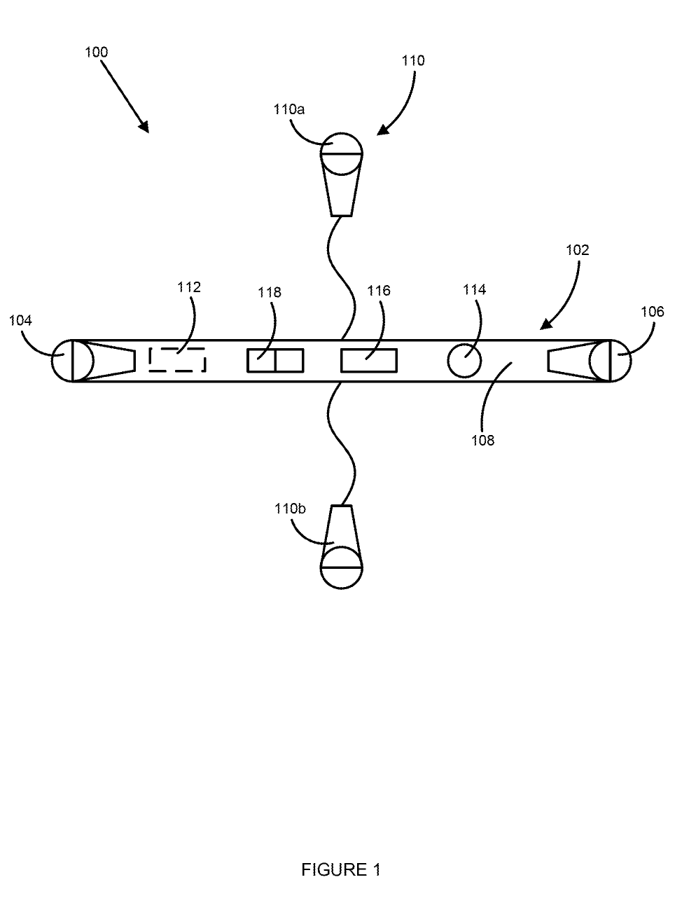

FIG. 1 illustrates an example recording arrangement 100, according to various embodiments. The recording arrangement 100 may include a binaural recording device 102. The binaural recording device 102 may be designed to produce recorded audio signals that imitate a human's hearing. For example, the binaural recording device 102 may include a first microphone 104 to sense sound that a first ear of a human would hear and a second microphone 106 to sense sound that a second ear of a human would hear if positioned at the location of the binaural recording device 102. The first microphone 104 and the second microphone 106 may be located a distance apart equal to approximately the average distance between the ears of an adult human. In other embodiments, the distance between the first microphone 104 and the second microphone 106 may be adjustable.

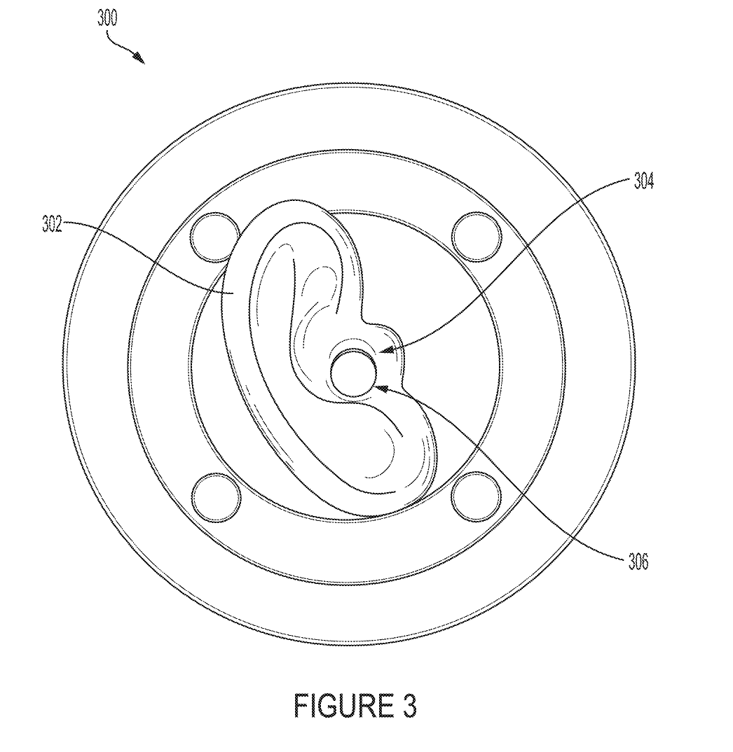

The first microphone 104 may be directed in a first direction and the second microphone 106 may be directed in a second direction opposite to the first direction. Further, an ear-shaped fixture, or ear-shaped fixtures, (such as the ear-shaped fixture 302 of FIG. 3) may be coupled to the first microphone 104 and/or the second microphone 106 to direct and/or affect sounds entering the first microphone 104 and/or the second microphone 106 as a human ear would direct and/or affect sounds entering a human ear canal. In particular, a first ear-shaped fixture may be coupled to the first microphone 104 and a second ear-shaped fixture may be coupled to the second microphone 106. In some embodiments, the ear-shaped fixtures may be omitted from the first microphone 104, the second microphone 106, or both of the first microphone 104 and the second microphone 106.

The binaural recording device 102 may further include a fixture 108. The fixture 108 may extend between the first microphone 104 and the second microphone 106 and may maintain the positions of the first microphone 104 and the second microphone 106, and/or a distance between the first microphone 104 and the second microphone 106. For example, the first microphone 104 may be coupled at a first side of the fixture 108 and the second microphone 106 may be coupled at a second side of the fixture 108, the second side being opposite to the first side. In embodiments where the distance between the first microphone 104 and the second microphone 106 is adjustable, the first microphone 104 and/or the second microphone 106 may be adjustably coupled to the fixture 108 and/or a length of the fixture 108 may be adjustable to support adjustment of the distance between the first microphone 104 and the second microphone 106.

The recording arrangement 100 may further include one or more directional microphones 110. The directional microphones 110 may be omnidirectional microphones (where the microphones respond equally to sounds coming from any direction), unidirectional microphones (where the microphones have greater sensitivity to sounds coming from a certain direction), or some combination thereof. In some embodiments, the directional microphones 110 may include microelectro-mechanical system (MEMS) microphones. Further, in some embodiments, the directional microphones 110 may each include an array of MEMS microphones, which may allow the directional microphones 110 to perform beamforming and be more sensitive to sound coming from one or more specific direction. A beamforming algorithm of the MEMS microphones may be modified, which may cause the MEMS microphones the radius of sound that the MEMS is sensitive to increase or decrease. For example, a directional microphone of the directional microphones 110 facing a front portion of the binaural recording device 102 may have the beamforming algorithm associated with the directional microphone modified to increase a radius of sounds to which the directional microphone is sensitive.

In the illustrated embodiment, the directional microphones 110 include a first directional microphone 110a and a second directional microphone 110b. However, in other embodiments, the recording arrangement 100 may include more than or less than two directional microphones 110. For example, in some embodiments the first directional microphone 110a or the second directional microphone 110b may be omitted from the recording arrangement 100.

Further, in the illustrated embodiments, the first directional microphone 110a may be oriented in a first direction that is substantially perpendicular (within five degrees) to the orientation of the first microphone 104 and the second microphone 106 of the binaural recording device 102. The second directional microphone 110b may be oriented in a second direction that is substantially perpendicular (within five degrees) to the orientation of the first microphone 104 and the second microphone 106 of the binaural recording device 102, wherein the second direction is opposite to the first direction. The first direction may be referred to as a forward direction from the binaural recording device 102 and may correspond to a front portion of the ear-shaped fixtures. The second direction may be referred to as a rear direction from the binaural recording device 102 and may correspond to a back portion of the ear-shaped fixtures. In other embodiments, the first directional microphone 110a and the second directional microphone 110b may be oriented in other directions. Further, in other embodiments, the recording arrangement 100 may include additional directional microphones, which may be oriented in the first direction, the second direction, other directions, or some combination thereof. It is to be understood that the directions of orientation of the first microphone 104, the second microphone 106, and the directional microphones 110 include directions in all three-dimensions and are not limited to the two-dimensions that are representable by the two-dimensional medium of the drawings. For example, the first directional microphone 110a may be tilted in upward or downward directions (in the z-coordinate plane) relative to a surface on which the fixture 108 is placed, as well as being oriented in directions within the x-coordinate and y-coordinate planes.

The directional microphones 110 may be positioned at varying distances from the fixture 108. In the illustrated example, the first directional microphone 110a and the second directional microphone 110b are shown being positioned equidistance from the fixture 108 in the first direction and the second direction, respectively. In other embodiments, a distance between the first directional microphone 110a and the fixture 108 and a distance between the second directional microphone 110b and the fixture 108 may be different. Further, additional directional microphones 110 may be positioned at the same distance from the fixture 108, at different distances from the fixture 108, or some combination thereof.

The recording arrangement 100 may further include processing circuitry 112. The processing circuitry 112 may receive audio signals from the first microphone 104, the second microphone 106, and/or the directional microphones 110 based on the sounds sensed by the first microphone 104, the second microphone 106, and/or the directional microphones 110. The processing circuitry 112 may receive the signals via wired connections, wireless connections, or some combination thereof, formed with the first microphone 104, the second microphone 106, and/or the directional microphones 110. For example, in some embodiments, the first microphone 104 and the second microphone 106 may have wired connections to the processing circuitry 112, and the directional microphones 110 may have wireless connections with the processing circuitry 112.

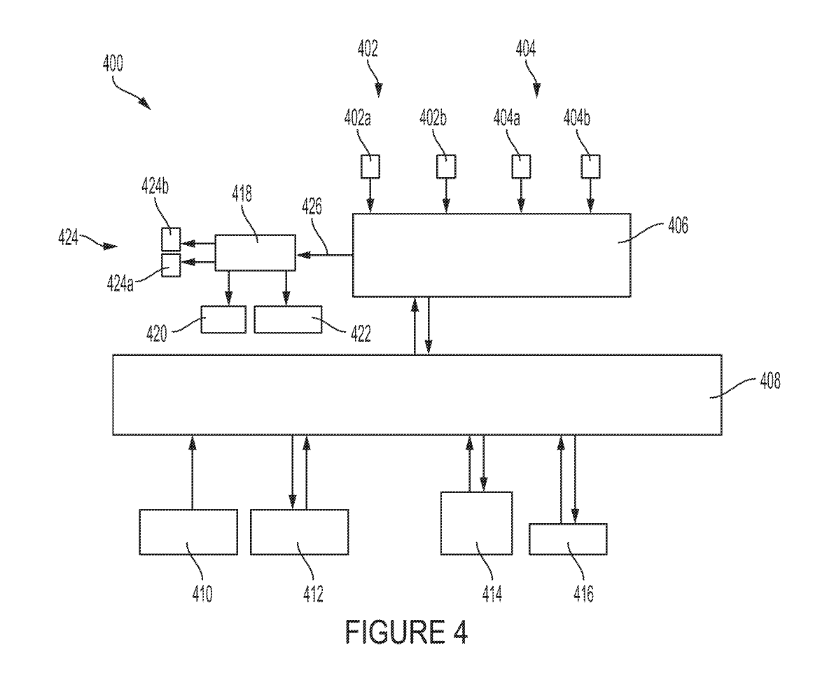

The processing circuitry 112 may process the audio signals and output results of the processing to an output 114 of the binaural recording device 102. The processing of the audio signals via the processing circuitry 112 is described further in relation to FIG. 4. While the output 114 is illustrated as a single output, it is to be understood that the output 114 may be more than one output. Further, the output 114 may include multiple different output types including, but not limited to, stereo outputs, universal serial bus (USB) port outputs, serial outputs (such as RS-232 outputs), digital storage media outputs, graphical display outputs (such as high definition multimedia interface (HDMI) outputs, digital visual interface (DVI) outputs, video graphics array (VGA) outputs, and/or serial digital interface (SDI) outputs, S-video outputs), or some combination thereof. In some embodiments, the output 114 may include wireless output circuitry that may wirelessly transmit the results of processing the audio signals. Further, in some embodiments, one or more of the outputs may operate as an input/output port, wherein the output may receive signals from another device (such as a computer or other computing device) and output signals to the other device.

The binaural recording device 102 may further include a user interface 118. The user interface 118 may be located on one or more surfaces of the fixture 108 and may receive inputs from a user of the binaural recording device 102. The user interface 118 may include an input device that may be interacted with by a user, include, but not limited to, buttons, switches, other actuators, a touch screen, or some combination thereof. The user interface 118 may be coupled to the processing circuitry 112 and may provide inputs received by the user interface 118 to the processing circuitry 112. In some embodiments, the user interface 118 may be omitted from the binaural recording device 102.

The binaural recording device 102 may further include a display 116. The display 116 may include lights, a visual display (such as a monitor), speakers, or some combination thereof. The display 116 may be coupled to the processing circuitry 112 and may receive data from the processing circuitry 112 that causes the display 116 to display an output, such as lighting up lights, displaying a visual representation on the visual display, omitting a sound from the speakers, or some combination thereof. In embodiments where the user interface 118 is a touch screen, the display 116 and the user interface 118 may be combined into a single element. In other embodiments, the display 116 may be omitted from the binaural recording device 102.

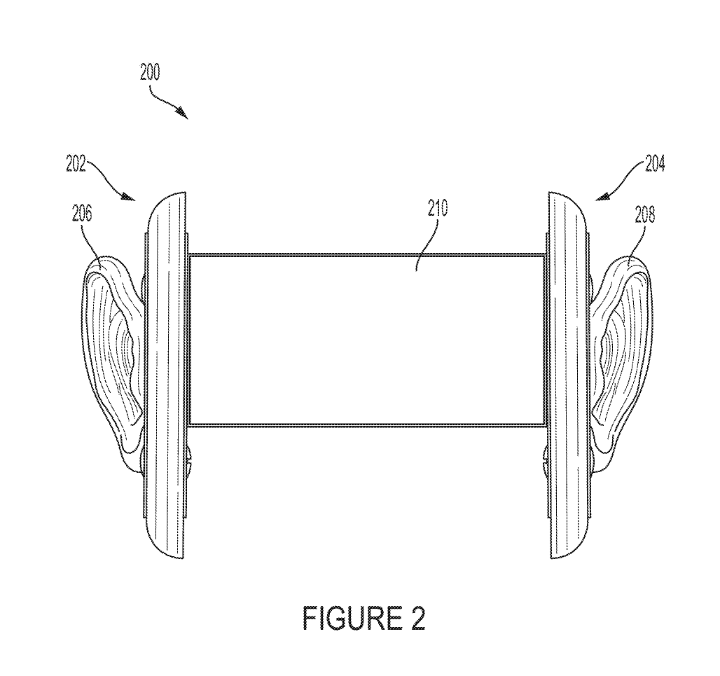

FIG. 2 illustrates an example binaural recording device 200, according to various embodiments. The binaural recording device 200 illustrated may be implemented in the recording arrangement 100 (FIG. 1) as the binaural recording device 102 (FIG. 1). Further, it is to be understood that the binaural recording device 200 is one example of a binaural recording device that may be implemented in the recording arrangement 100 and other binaural recording devices that fulfill the description of the binaural recording device 102 may be implemented in the recording arrangement 100.

The binaural recording device 200 may include a first microphone fixture 202 and a second microphone fixture 204. The first microphone fixture 202 may include a first ear-shaped fixture 206 and a first microphone (such as the first microphone 104 (FIG. 1)). The first ear-shaped fixture 206 may be shaped to resemble a human ear with the microphone located in an aperture located toward a center of the first ear-shaped fixture 206. In particular, the aperture may be formed in a location of the first ear-shaped fixture 206, where an ear canal would be located within a human ear. The first ear-shaped fixture 206 may direct and/or affect sounds to enter the first microphone as a human ear would direct and/or affect sounds to enter a human ear canal. The first ear-shaped fixture 206 and the first microphone may be designed to imitate what a human ear would hear when positioned at the location of the first microphone fixture 202. An example of a microphone fixture that may be implemented as and/or that may be representative of the first microphone fixture 202 is illustrated by the microphone fixture 300 of FIG. 3.

The second microphone fixture 204 may include a second ear-shaped fixture 208 and a second microphone (such as the second microphone 106 (FIG. 1)). The second ear-shaped fixture 208 may be shaped to resemble a human ear with the microphone located in an aperture located toward a center of the second ear-shaped fixture 208. In particular, the aperture may be formed in a location of the second ear-shaped fixture 208, where an ear canal would be located within a human ear. The second ear-shaped fixture 208 may be a mirror image of the first ear-shaped fixture 206 and may resemble the complementary human ear to the human ear resembled by the first ear-shaped fixture 206. For example, if the first ear-shaped fixture 206 resembles a human's right ear, the second ear-shaped fixture 208 may resemble a human's left ear. Accordingly, a portion of the first ear-shaped fixture 206 shaped to resemble a front portion of a human ear may be oriented in a same direction as a portion of the second ear-shaped fixture 208 shaped to resemble a front portion of a human ear. The second ear-shaped fixture 208 may direct and/or affect sounds to enter the second microphone as a human ear would direct and/or affect sounds to enter a human ear canal. The second ear-shaped fixture 208 and the second microphone may be designed to imitate what a human ear would hear when positioned at the location of the second microphone fixture 204. An example of a microphone fixture that may be implemented as and/or that may be representative of the second microphone fixture 204 is illustrated by the microphone fixture 300 of FIG. 3. In combination, the first ear-shaped fixture 206 with the first microphone and the second ear-shaped fixture 208 may be designed to imitate what a human would hear when located in the position of the binaural recording device 200.

The binaural recording device 200 may further include a fixture 210 to which the first microphone fixture 202 and the second microphone fixture 204 may be mounted. The fixture 210 may include one or more of the features of the fixture 108 (FIG. 1). The fixture 210 may maintain and/or adjust positions of the first microphone fixture 202 and/or the second microphone fixture 204. For example, the fixture 210 may maintain and/or adjust the positions of the first microphone fixture 202 and/or the second microphone fixture 204 such that the first microphone fixture 202 and the second microphone fixture 204 are located at distances apart within a certain distance of the average distance between the ears of an adult human. The fixture 210 may further include the processing circuitry 112 (FIG. 1), the output 114 (FIG. 1), the display 116 (FIG. 1), the user interface 118 (FIG. 1), or some combination thereof. In particular, the processing circuitry 112 may be located within the fixture 210. The output 114 may be located at one of the surfaces of the fixture 210, within the fixture 210 (in embodiments where the output 114 includes wireless output circuitry), or some combination thereof.

FIG. 3 illustrates an example microphone fixture 300, according to various embodiments. The microphone fixture 300 may be implemented as and/or representative of the first microphone fixture 202 (FIG. 2) and/or the second microphone fixture 204 (FIG. 2) of the binaural recording device 200 (FIG. 2).

The microphone fixture 300 may include an ear-shaped fixture 302. The ear-shaped fixture 302 may include one or more of the features of the first ear-shaped fixture 206 (FIG. 2) and/or the second ear-shaped fixture 208 (FIG. 2). The ear-shaped fixture 302 illustrated may resemble a human's right ear. Another embodiment of an ear-shaped fixture may resemble a human's left ear, where the ear-shaped fixture that resembles the human's left ear may be a mirror image of the ear-shaped fixture 302.

The ear-shaped fixture 302 may include an aperture 304 formed in a center of the ear-shaped fixture 302. The aperture 304 may be formed toward a center of the ear-shaped fixture 302, in a location where an ear canal would be formed in a human ear.

The microphone fixture 300 may further include a microphone 306. The microphone 306 may include one or more of the features of the first microphone 104 (FIG. 1) and/or the second microphone 106 (FIG. 1). The microphone 306 may be located concentric to the aperture 304. In particular, the microphone 306 may be located where an ear canal would be formed in the ear-shaped fixture 302 and may be oriented with the microphone 306 directed out of the ear-shaped fixture 302. The ear-shaped fixture 302 may direct and/or affect sound to enter the microphone 306 as to imitate how sound would enter the ear canal of a human ear.

FIG. 4 illustrates example processing circuitry 400, according to various embodiments. The processing circuitry 400 may be implemented in the processing circuitry 112 (FIG. 1) and may be located within and/or on the fixture 108 (FIG. 1). In other embodiments, the processing circuitry 400 may be located within one of the other components of the recording arrangement 100 (FIG. 1), in a computer device coupled to the recording arrangement 100, in an audio processing device coupled to the recording arrangement 100, or some combination thereof. The illustrated embodiment of the processing circuitry 400 corresponds to the recording arrangement 100. However, it is to be understood that components of the processing circuitry 400 may vary for other embodiments of recording arrangements, as is described throughout the description of the processing circuitry 400.

The processing circuitry 400 may include one or more microphone inputs 402 and one or more directional microphone phone inputs 404. In the illustrated embodiments, the processing circuitry includes a first microphone input 402a, a second microphone input 402b, a first directional microphone input 404a, and a second directional microphone 404b input. The first microphone input 402a may correspond to the first microphone 104 (FIG. 1) and the second microphone input 402b may correspond to the second microphone 106 (FIG. 1). In particular, the first microphone input 402a may be coupled to a first microphone of a binaural recording device (such as the binaural recording device 102 (FIG. 1)) and the second microphone input 402b may be coupled to a second microphone of the binaural recording device, such that the first microphone input 402a and the second microphone input 402b may receive audio inputs for binaural recording. Further, the first microphone input 402a may correspond to a first audio channel and the second microphone input 402b may correspond to a second audio channel.

The first directional microphone input 404a may correspond to a first directional microphone (such as the first directional microphone 110a (FIG. 1)) and the second directional microphone input 404b may correspond to a second directional microphone (such as the second directional microphone 110b (FIG. 1)). In particular, the first directional microphone input 404a and the second directional microphone input 404b may receive audio inputs corresponding to sounds captured in an environment surrounding a binaural recording device (such as the binaural recording device 102 (FIG. 1)). Further, the first directional microphone input 404a may correspond to a third audio channel and the second directional microphone input 404b may correspond to a fourth audio channel. In other embodiments, the processing circuitry 400 may include more or less directional microphone inputs 404 than the two directional microphone inputs illustrated, wherein each of the directional microphone inputs 404 may correspond to a directional microphone (such as the directional microphones 110 (FIG. 1)) and an audio channel, respectively.

The processing circuitry 400 may further include an audio processor 406. The audio processor 406 may include audio processing circuitry, an audio processing semiconductor device, or some combination thereof. The audio processor 406 may receive audio inputs from the first microphone input 402a, the second microphone input 402b, the first directional microphone input 404a, and the second directional microphone input 404b. For example, the audio processor 406 may receive a first audio signal input from the first microphone input 402a, a second audio signal input from the second microphone input 402b, a third audio signal input from the first directional microphone input 404a, and a fourth audio signal input from the second directional microphone input 404b. The audio processor 406 may process and mix the first audio signal, the second audio signal, the third audio signal, and the fourth audio signal to produce a first audio signal on a first output channel of the output 426 and a second audio signal on a second output channel of the output 426, as is described further throughout this disclosure. In embodiments where the processing circuitry 400 includes more or less directional microphone inputs 404, microphone inputs 402 and the directional microphone inputs 404 may each correspond to a separate audio channel, respectively, and the audio processor 406 may process and/or mix all of the audio signals on the audio channels together to produce the output 426 having a first output audio channel and a second output audio channel.

The processing circuitry 400 may further include a master processor 408. The master processor 408 may control operation of the processing circuitry 400. In particular, the master processor 408 may provide instructions and/or data to other components of the processing circuitry 400, wherein the instructions and/or data may define operation of the other components of the processing circuitry 400.

The processing circuitry 400 may further include a user interface 410. The user interface 410 may include one or more of the features of the user interface 118 (FIG. 1). The user interface 410 may be coupled to the master processor 408. The user interface 410 may receive one or more inputs from a user and may provide the inputs to the master processor 408. In some embodiments, the user interface 410 may be omitted.

The processing circuitry 400 may further include a display 412. The display 412 may include one or more of the features of the display 116 (FIG. 1). The display 412 may be coupled to the master processor 408. The master processor 408 may provide data to the display 412 that causes the display 412 to display an output. In embodiments where the display 412 is a touch screen device, the display 412 may further receive inputs from a user and provide the inputs to the master processor 408. Further, in embodiments where the display 412 is the touch screen device, the user interface 410 and the display 412 may be combined as a single element. In other embodiments, the display 412 may be omitted from the processing circuitry 400.

The processing circuitry 400 may further include storage media 414. The storage media 414 may be coupled to the master processor 408 and may store data received from the master processor 408 and/or accessible by the master processor 408. The storage media 414 may include hard drives, random-access memory devices, read-only memory devices, flash memory devices, or some combination thereof. In some embodiments, the storage media 414 may further, or alternatively, include external memory devices, such as compact discs, flash drives, tape drives, magnetic tape drives, or some combination thereof, which may be removably coupled to the master processor 408.

The processing circuitry 400 may further include a communication port 416. The communication port 416 may provide for communication with external devices, such as a computer device. The communication port 416 may include a USB port, a serial port (such as an RS-232 port), a parallel port, or some combination thereof. The communication port 416 may be coupled to the master processor 408 and may provide for communication between the master processor 408 and the external device.

In some embodiments, the communication port 416 may include wireless circuitry to provide wireless communication between the processing circuitry 400 and one or more devices, including the first microphone 104, the second microphone 106, the directional microphones 110, external devices (such as a computer device), or some combination thereof. The wireless circuitry may further be able to determine, or facilitate determination of, positions of one or more of the devices relative to the processing circuitry 400 and/or a binaural recording device (such as the binaural recording device 102). The wireless circuitry may indicate positions of the devices to the master processor 408. In other embodiments, the communication port 416 may be omitted from the processing circuitry 400.

The master processor 408 may further be coupled to the audio processor 406. The master processor 408 may utilize inputs, data, and/or communication received from the user interface 410, the display 412, the storage media 414, the communication port 416, or some combination thereof, to generate data and/or commands to facilitate processing of the audio signals by the audio processor 406. For example, inputs from the user interface 410 and/or the communication port 416 may indicate positions of the directional microphones, such as a first directional microphone corresponding to the first directional microphone input 404a and a second directional microphone corresponding to the second directional microphone input 404b. Based on the positions, the master processor 408 may determine weights to be utilized in processing of the audio signals, wherein audio signals associated with high weights may have greater effect on the audio signals on the two output audio channels of the output 426 than audio signals associated with lower weights. In some embodiments, the audio signals corresponding to directional microphones located close to the processing circuitry 400 and/or the binaural recording device may be assigned higher weight than audio channels corresponding to directional microphones located farther away from the processing circuitry 400 and/or the binaural recording device.

In some embodiments, audio signals corresponding to directional microphones at certain angles to an orientation of the binaural recording device may be assigned higher weights than audio signals corresponding to other directional microphones located at other angles to the orientation of the binaural recording device. For example, an audio signal corresponding to a directional microphone located perpendicular to an extension of the binaural recording device (wherein the first microphone 104 and the second microphone 106 are directed along the extension of the binaural recording device 102) may be assigned a lower weight than an audio signal corresponding to a directional microphone located at an angle of 45 degrees from the extension of the binaural recording device.

In some embodiments, the master processor 408 may determine delay factors to be applied to one or more of the audio signals based on the determined positions of the directional microphones corresponding to the audio signals, inputs from the user interface 410, the display 412, the storage media 414, and/or the communication port 416, or some combination thereof. For example, the master processor 408 may determine that an audio signal captured by a directional microphone should be delayed by a certain time period or time factor based on a distance from the directional microphone to the binaural recording device. The audio signal may be delayed to cause the phase of the audio signal to be lined up with other audio signals for which processing is to be performed, which may prevent veer sounds from being produced when the audio processor 406 processes the audio signals. The master processor 408 may generate a delay factor based on the time period or the time factor. The master processor 408 may provide the delay factor to the audio processor 406, which may cause the audio processor 406 to delay the audio signal corresponding to the directional microphone by the time period or the time factor.

In some embodiments, the master processor 408 may determine attenuation factors to be applied to one or more of the audio signals based on the determined positions of the directional microphones corresponding to the audio signals, inputs from the user interface 410, the display 412, the storage media 414, and/or the communication port 416, or some combination thereof. For example, the master processor 408 may determine that an audio signal captured by a directional microphone should be attenuated by a certain amount or factor based on a distance from the directional microphone to the binaural recording device. The master processor 408 may generate an attenuation factor based on the amount or factor of attenuation. The master processor 408 may provide the attenuation factor to the audio processor 406, which may cause the audio processor 406 to attenuate the audio signal corresponding to the directional microphone by the amount or factor of attenuation.

In some embodiments, the master processor 408 may receive, via the user interface 410, the display 412, the storage media 414, and/or the communication port 416, an indication of environmental factors associated with an environment of a recording arrangement (such as the recording arrangement 100 (FIG. 1)) and/or an indication of environmental factors to imitate to be utilized in processing the audio channels. For example, the master processor 408 may receive an indication to imitate the environmental factor of the recording arrangement being located within water. Based on the indication, the master processor 408 may modify the delay factor and/or the attenuation factor to be consistent with the recording arrangement being located within water. In particular, since sound travels faster and has greater attenuation in water than in air, the master processor 408 may modify the delay factor to correspond to a shorter time period and/or may modify the attenuation factor to correspond to a greater amount of attenuation.

In some embodiments, the master processor 408 may generate two separate weightings, delay factors, and/or attenuation factors for each of the audio signals corresponding to the directional microphones, wherein the separate weightings, delay factors, and/or attenuation factors are to be applied to produce the two audio signals on the output audio channels of the output 426. In particular, each audio signal corresponding to the directional microphones may be assigned a first weighting, delay factor, and/or attenuation factor to be applied to the audio signal during processing to produce an audio signal on the first output audio channel of the output 426. Further, each audio signal corresponding to the directional microphones may be assigned a second weighting, delay factor, and/or attenuation factor to be applied to the audio signal during processing to produce an audio signal on the second output audio channel of the output 426. The master processor 408 may generate the separate weightings, delay factors, and/or attenuation factors based on differences between a distance and/or angle between the directional microphone and the first microphone of a binaural recording device, and a distance and/or angle between the directional microphone and the second microphone of the binaural recording device.

For example, in instances where the directional microphone is located closer to the first microphone than the second microphone, the master processor 408 may generate a first weighting corresponding to the first microphone that is greater than a second weighting corresponding to the second microphone. The first weighting may be applied to the audio signals corresponding to directional microphone to produce an audio signal on the first audio channel of the output 426 and the second weighting may be applied to the audio signals to produce an audio signal on the second audio channel of the output 426. In particular, the first audio channel of the output 426 may correspond to one side of the binaural recording device (where the first microphone is located) and the second output audio channel of the output 426 may correspond to an opposite side of the binaural recording device (where the second microphone is located). Accordingly, the first weighting is applied to audio signals processed to produce the audio signal on the first output audio channel of the output 426 based on the correspondence with the first microphone and the second weighting is applied to audio signals processed to produce the audio signal on the second output audio channel of the output 426 based on the correspondence with the second microphone.

In some embodiments, a user of the binaural recording device may define the weightings, the delay factors, the attenuation factors, or some combination thereof. For example, the master processor 408 may receive indications of weightings, delay factors, and/or attenuation factors from the user via the user interface 410, the display 412, and/or the communication port 416. The processing circuitry 400 may utilize the weightings, delay factors, and/or the attenuation factors received from the user for processing/convolution of the audio signals.

The audio processor 406 may receive indications of the weightings, the delay factors, and/or the attenuation factors from the master processor 408 and convolve the impulse responses taken from the first microphone input 402a and the second microphone input 402b with the first directional microphone input 404a and the second directional microphone input 404b based on the weightings, the delay factors, and/or the attenuation factors. In particular, the audio processor 406 may convolve the impulse responses corresponding to the first microphone input 402a with the audio signal corresponding to the directional microphone inputs 404 to produce an audio signal on the first output audio channel of the output 426. The audio signal on the first output audio channel may be the audio signal corresponding to the first microphone input 402a with directional-enhancement from the audio signals corresponding to the directional microphone inputs 404. Processing of the audio signal corresponding to the first microphone input 402a with audio signals corresponding to the directional microphone inputs 404 may include applying the weightings, the delay factors, and/or the attenuation factors to the audio signals corresponding to the directional microphone inputs 404. Further, the audio processor 406 may convolve audio signals corresponding to the directional microphone inputs 404 with a Head Related Impulse Response (HRIR) and mix the resulting audio signal with the audio signal corresponding to the first microphone input 402a as part of the processing. For example, the audio processor 406 may record and store an impulse response from the audio signal corresponding to the first microphone input 402a and convolve in the frequency domain, the impulse response with the audio signals corresponding to the directional microphone inputs 404.

Further, the audio processor 406 may convolve the impulse responses corresponding to the second microphone input 402b with the audio signals corresponding to the directional microphone inputs 404 to produce an audio signal on the second output audio channel of the output 426. The audio signal on the second output audio channel may be the audio signal corresponding to the second microphone input 402b with directional-enhancement from the audio signals corresponding to the directional microphone inputs 404. Processing of the impulse responses corresponding to the second microphone input 402b with the audio signals corresponding to the directional microphone inputs 404 may include applying the weightings, the delay factors, and/or the attenuation factors to the audio signals corresponding to the directional microphone inputs 404. Further, audio processor 406 may convolve the audio signals corresponding to the directional microphone inputs 404 with a HRIR and mix the resulting audio signal with the audio signal corresponding to the second microphone input 402b as part of the processing. For example, the audio processor 406 may record and store an impulse response from the audio signal corresponding to the second microphone input 402b and convolve, in the frequency domain, the impulse response with the audio signals corresponding to the directional microphone inputs 404.

In some embodiments, the audio processor 406 may further encode and/or decode the audio signals. For example, the audio processor 406 may receive the audio signals corresponding to the microphone inputs 402 and the directional microphone inputs 404, may process the audio signals, and may encode the processed audio signals to produce the first output audio signal and the second output audio signal on the output 426. The audio processor 406 may encode and/or decode the audio signals in any audio encoding format, such as waveform audio (WAV) file format, audio interchange file format (AIFF), AU file format, moving picture experts group (MPEG) file format, windows media audio (WMA) file format, MP3 file format, and/or advanced audio coding (AAC) file format.

The processing circuitry 400 may further include stereo output circuitry 418. The stereo output circuitry 418 may receive the audio signals on the output 426 from the audio processor 406 and may direct the audio signals to audio outputs.

The processing circuitry 400 may further include a stereo output 420, a headphone output 422, XLR outputs 424, or some combination thereof. The stereo output 420, the headphone output 422, and/or the XLR outputs 424 may be included in the output 114 (FIG. 1). The stereo output circuitry 418 may direct the audio signals from the output 426 to the stereo output 420, the headphone output 422, the XLR outputs 424, or some combination thereof. In particular, the stereo output circuitry 418 may direct the first audio signal received on the first output audio channel of the output 426 and the second audio signal received on the second output audio channel of the output 426 to the stereo output 420, the headphone 422, the XLR outputs 424, or some combination thereof. The stereo output circuitry 418 may further direct the first audio signal and the second audio signal to certain audio channels of each of the stereo output 420, the headphone output 422, and/or the XLR outputs 424. For example, the stereo output circuitry 418 may direct the first audio signal to an audio channel associated with a right side output and may direct the second audio signal to an audio channel associated with a left side output of each of the stereo output 420, the headphone output 422, and/or the XLR outputs 424. For example, in particular, the stereo output circuitry 418 may direct the first audio signal to a right XLR output 424a of the XLR outputs 424 and the second audio signal to a left XLR output 424b of the XLR outputs 424. It is to be understood that the stereo output 420, the headphone output 422, and the XLR outputs 424 are some examples of audio outputs that may be implemented in a processing circuitry 400 and, in other embodiments, other audio outputs may be implemented in the processing circuitry 400.

While the description of the processing circuitry 400 describes the audio processor 406 as performing certain operations and the master processor 408 performing other operations, it is to be understood that the master processor 408 may perform some or all of the operations described as being performed by the audio processor 406 and the audio processor 406 may perform some or all of the operations described as being performed by the master processor 408 in other embodiments. Further, in some embodiments, the master processor 408, the user interface 410, the display 412, the storage media 414, and/or the communication port 416 may be implemented in a separate device (such as a computer device) coupled to the audio processor 406.

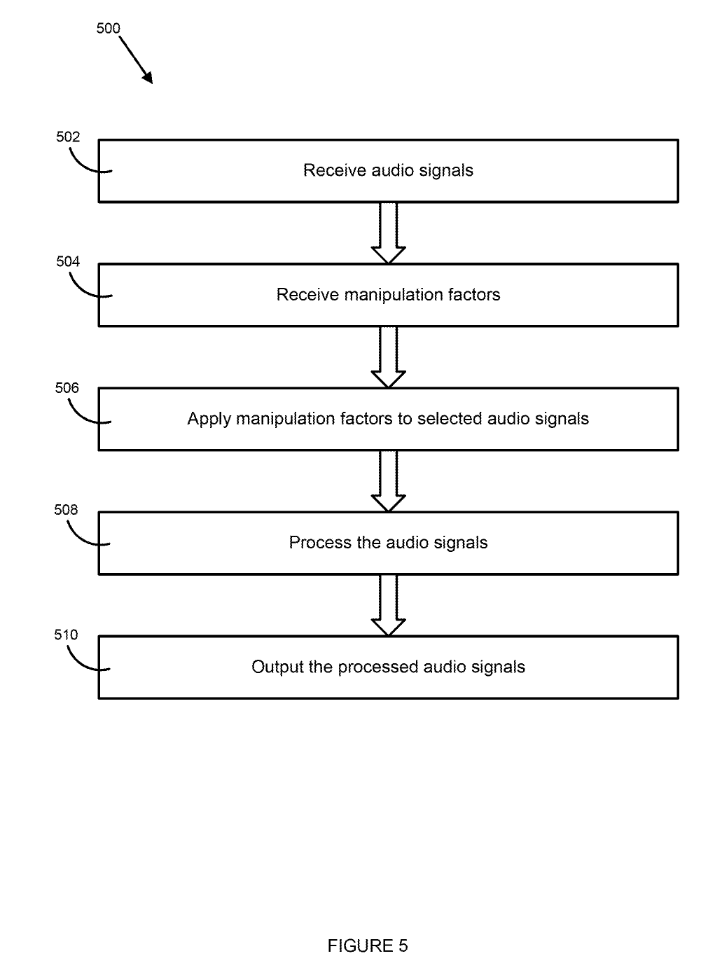

FIG. 5 illustrates an example procedure 500 for performance by the processing circuitry 400 of FIG. 4, according to various embodiments. While the stages of procedure 500 are described in one order herein, it is to be understood that the order of performance of the stages may vary during other embodiments. Further, in some embodiments, one or more of the stages may be performed concurrently.

In stage 502, the processing circuitry 400 may receive audio signals from microphones within a recording arrangement (such as the recording arrangement 100 (FIG. 1)). For example, the processing circuitry 400 may receive audio signals from the first microphone 104 (FIG. 1), the second microphone 106 (FIG. 1), and/or the directional microphones 110 (FIG. 1) via the microphone inputs 402 and/or the directional microphone inputs 404.

In stage 504, the processing circuitry 400 may receive manipulation factors. The manipulation factors may include the weightings, the delay factors, and/or the attenuation factors described in relation to FIG. 4. Receiving the manipulation factors may include receiving information associated with the recording arrangement (such as positions of the directional microphones relative to the binaural recording device (such as the binaural recording device 102 (FIG. 1)), environmental factors of the recording arrangement, or some combination thereof). The master processor 408 (FIG. 4) may then determine the manipulation factors based on the received information associated with the recording arrangement. In some embodiments, receiving the manipulation factors may include receiving user input that provide the manipulation factors. The user input may be received via the user interface 410 (FIG. 4), the display 412 (FIG. 4), the storage media 414 (FIG. 4), the communication port 416 (FIG. 4), or some combination thereof.

In stage 506, the processing circuitry 400 may apply the manipulation factors to selected audio signals. In particular, the processing circuitry 400 may apply the manipulation factors to the audio signals associated with the directional microphones, as described throughout this disclosure.

In stage 508, the processing circuitry 400 may process and mix the audio signals. In particular, the audio processor 406 (FIG. 4) may process and mix the audio signals to produce the first audio signal and the second audio signal on the first output audio channel and the second output audio channel of the output 426 (FIG. 4), as described throughout this disclosure.

In stage 510, the processing circuitry 400 may output the processed audio signals. In particular, the stereo output circuitry 418 (FIG. 4) may receive the first audio signal and the second audio signal from the output 426. The stereo output circuitry 418 may direct the first audio signal and the second audio signal to the proper audio channels of the outputs of the processing circuitry 400, such as the stereo output 420, the headphone output 422, the XLR output, or some combination thereof.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

I claim:

1. A binaural recording device, comprising:
a first microphone fixture including a first ear-shaped fixture and a first microphone, wherein the first ear-shaped fixture directs sounds to enter the first microphone;
a second microphone fixture including a second ear-shaped fixture and a second microphone; wherein the second ear-shaped fixture directs sounds to enter the second microphone; and
a mounting fixture coupled to the first microphone fixture and the second microphone fixture for maintaining and/or adjusting a position of the first microphone fixture and/or the second microphone fixture.

2. The binaural recording device of claim 1, wherein the first ear-shaped fixture is shaped to resemble a human ear with the first microphone located in an aperture located toward a center of the first ear-shaped fixture as a human ear would direct and/or affect sounds to enter a human ear canal; and wherein the second ear-shaped fixture is shaped to resemble a human ear with the second microphone located in an aperture located toward a center of the second ear-shaped fixture as a human ear would direct and/or affect sounds to enter a human ear canal.

3. The binaural recording device of claim 1, wherein the second ear-shaped fixture is a mirror image of the first ear-shaped fixture.

4. The binaural recording device of claim 1, wherein the mounting fixture maintains and/or adjust positions of the first microphone fixture and/or the second microphone fixture such that the first microphone fixture and the second microphone fixture are located at distances apart within a certain distance of the average distance between the ears of an adult human.

5. The binaural recording device of claim 2, wherein the mounting fixture further comprises processing circuitry, an output, a display, a user interface or combination thereof.

6. The binaural recording device of claim 5, wherein the processing circuitry is located within the mounting fixture.

7. The binaural recording device of claim 5, wherein the output is a wireless output circuitry and located within the mounting fixture.

8. The binaural recording device of claim 5, wherein the output is located on a first surface of the mounting fixture.

9. The binaural recording device of claim 1, wherein the first microphone is directed in a first direction and the second microphone is directed in a second direction opposite the first direction.

10. The binaural recording device of claim 1, wherein the first microphone is coupled to a first side of the mounting fixture and second microphone is coupled to a second side of the mounting fixture.

11. A recording arrangement, comprising the binaural recording device of claim 1.

12. The recording arrangement of claim 11, further comprising one or more directional microphones.

13. The recording arrangement of claim 12, wherein the one or more directional microphones comprises one or more omnidirectional microphones, unidirectional microphones or combination thereof.

14. The recording arrangement of claim 13, wherein the one or more directional microphones comprises one or more microelectro-mechanical system (MEMS) microphones.

15. The recording arrangement of claim 12, wherein the one or more directional microphones includes an array of MEMS microphones to allow the directional microphones to perform beamforming and increase sensitive to sound coming from one or more specific direction.

16. The binaural recording device of claim 12, wherein the one or more directional microphones include a first directional microphone oriented in a first direction that is substantially perpendicular (within five degrees) to the orientation of the first microphone and the second microphone of the binaural recording device; and a second directional microphone oriented in a second direction that is substantially perpendicular (within five degrees) to the orientation of the first microphone and the second microphone of the binaural recording device, wherein the second direction is opposite to the first direction.
